(19) United States
(12) Patent Application Publication
(10) Pub. No.: US 2003/0037828 A1
(43) Pub. Date: Feb. 27, 2003

(54) Electro-hydraulic module for transmission control

(75) Inventors: Helmut Gander, Rochester, MI (US); Michael Thorum, Lake Orion, MI (US)

Correspondence Address: SIEMENS CORPORATION, ATTN: INTELLECTUAL PROPERTY ADMINISTRATION, 186 WOOD AVENUE SOUTH, ISELIN, NJ, 08830, US

(73) Assignee: Siemens VDO Automotive Corporation

(21) Appl. No.: 10/215,136

(22) Filed: Aug. 8, 2002

Related U.S. Application Data
(60) Provisional application No. 60/313,868, filed on Aug. 21, 2001.

(51) Int. Cl. F16K 1/00

(52) U.S. Cl. 137/884

(57) ABSTRACT

An electro-hydraulic module for a vehicle transmission integrates control circuitry with a transmission valve body into a single unit. The valve body contains channels that route transmission fluid. The module includes electronic circuitry sandwiched between the valve body and a cover, eliminating the need for a separate circuit plate to support the electronic circuitry. Solenoids may also be attached to the valve body for further integration.

### REFERENCE TO RELATED APPLICATIONS

This application claims priority to provisional application No. 60/313,868 filed on Aug. 21, 2001.

### TECHNICAL FIELD

The present invention relates to electro-hydraulic modules for vehicle transmissions, and more particularly the way in which one or more electronic circuits are connected to an electro-hydraulic transmission control module.

### BACKGROUND OF THE INVENTION

Automatic transmissions for vehicles are controlled by separate electronic circuits that are mounted somewhere in the vehicle and then connected via wires to the transmission and to the electronic components (e.g., sensors, actuators, etc.) inside the transmission.

Electro-hydraulic control of the transmission system is currently conducted via control circuitry attached to a base plate. The control circuitry is then attached to the transmission valve body for measuring transmission fluid pressure and controlling fluid flow within the valve. In short, the control circuitry is kept separate from the transmission valve body, requiring two separate installation steps when the transmission valve and its associated control circuitry are installed into the vehicle.

There is a need for a transmission valve assembly that reduces the overall number of parts in the assembly, thereby reducing manufacturing costs and improving reliability.

### SUMMARY OF THE INVENTION

Accordingly, an embodiment of the present invention is directed to an electro-hydraulic module that incorporates a transmission valve body, electronic control circuitry, and solenoids into a single device. Rather than using a separate circuit plate to support the electronic circuitry, the inventive structure attaches electronic components to the valve body itself. In one embodiment, the valve body also supports the solenoids. By eliminating the circuit plate and integrating multiple transmission valve components into a single module, the invention improves reliability and reduces assembly costs.

### BRIEF DESCRIPTION OF THE DRAWINGS

FIG. 1 is a bottom view of a valve body used in an electro-hydraulic module according to one embodiment of the invention;

FIG. 2 is a top view of the valve body of FIG. 1;

FIG. 3 is an exploded view of the electro-hydraulic module according to one embodiment of the invention;

FIG. 4 is an assembled view of the electro-hydraulic module shown in FIG. 3; and

FIG. 5 illustrates the electro-hydraulic module after solenoids have been attached.

### DETAILED DESCRIPTION OF THE EMBODIMENTS

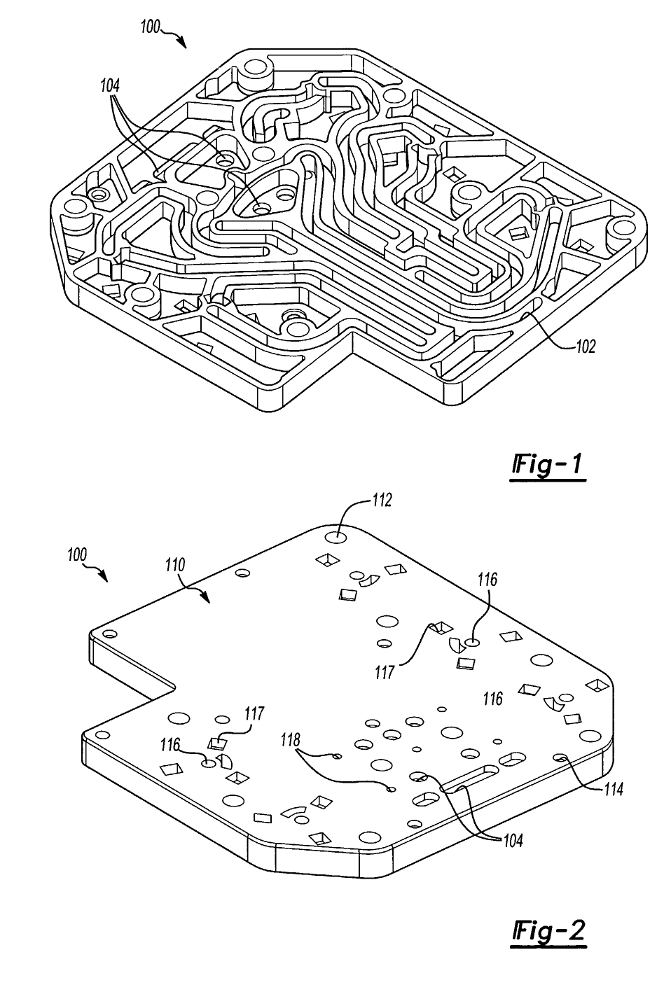

FIG. 1 illustrates an underside of a valve body 100 that forms a portion of a electro-hydraulic module according to one embodiment of the invention. The valve body 100 contains channels 102 that route transmission fluid through the valve body 100 as well as access holes 104 that are eventually used to attach electronics to other components in the module. The channels 102 can be configured to route transmission fluid in any desired direction and manner through the valve body 100. In one embodiment, the channels 102 can be customized to accommodate any desired fluid routing pattern. The valve body 100 can be manufactured in any known manner, such as die casting.

FIG. 2 illustrates a top surface 110 of the valve body 100. As shown in the Figure, the top surface 110 is preferably flat to provide a base for attaching electronic circuitry, such as a low temperature co-fired ceramic (LTCC) circuit and/or a flexible circuit. In a preferred embodiment, the top surface 110 has a surface finish that can accommodate components that are laminated and/or glued to the top surface 110. In essence, the top surface 110 of the valve body 100 acts as its own circuit plate, eliminating the need for a separate circuit plate to hold transmission valve control circuitry. In addition to the access holes 104, the valve body 100 may also include bolt holes 112 for attaching the completed module to a transmission, rivet holes 114 for attaching a module cover to the valve body 100, port holes 116 for directing transmission fluid from the valve body 100 to solenoids (not shown), and attachment holes 117 for attaching solenoids to the valve body 100, and pressure sensor holes 118 for measuring fluid pressure within the valve body. By configuring the valve body 100 in this way, the electronics and solenoids for the transmission valve can be supported on the valve body 100 itself rather than on a separate circuit plate.

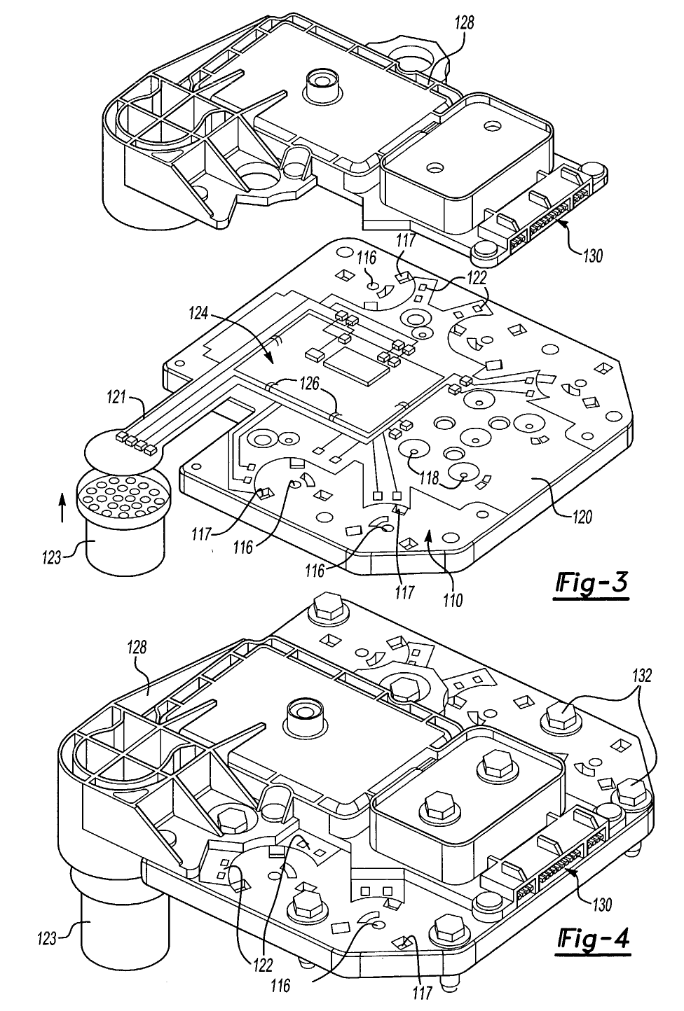

FIG. 3 is an exploded view showing additional portions of the electro-hydraulic module. In this embodiment, a flexible circuit 120 is laminated onto the flat top surface 110 of the valve body 100. The flexible circuit 120 can be made of foil or other flexible material that can support electronic circuitry. A portion 121 of the flexible circuit 120 may extend outside the boundaries of the top surface 110 so that it can be attached to a connector 123 via laser welding or other method. The flexibility of the flexible circuit 120 makes it easier to align the circuit 120 with or between other components without requiring tight manufacturing tolerances; any slight misalignments between the flexible circuit 120 and other components can be accommodated through the flexing action of the circuit 120. The flexible circuit 120 may have one or more contact pads 122 adapted to connect the circuit 120 to one or more solenoids. The contact pads 122 are disposed near the port holes 116 so that solenoids attached via the attachment holes 117 will contact the contact pads 122 and couple to the rest of the flexible circuit 120.

An LTCC circuit 124 may also be attached with adhesive to the valve body 100. In this embodiment, the LTCC circuit 124 and the flexible circuit 120 are connected together via wire bonds 126.

The module also includes a cover 128 for protecting the flexible circuit 120 and the LTCC circuit 124. In one embodiment, the cover 128 contains additional circuitry, such as pressure switches (not shown), that can communicate with the flexible circuit 120 and/or the LTCC circuit 124. With respect to pressure switches specifically, they are disposed directly over the pressure sensor holes 118 to measure the hydraulic pressure of the transmission fluid within the valve body 100. The cover 128 also may include an internal connector 130 for attaching the module to other electrical components.

The cover 128 is attached to the valve body 100 in any desired manner. In the embodiment shown in FIG. 3, the cover 128 is attached to the valve body 100 with rivets 132, but other connectors, such as screws or snaps, may also be used. Regardless of the specific type of connection scheme, the cover 128 and the valve body 100 should be connected to withstand heat, vibration, and other conditions that would normally be encountered by the transmission.

A seal (not shown) may be incorporated between the cover 128 and the valve body 100 to further protect the circuitry 120, 124 from outside contamination. FIG. 4 shows the module structure after the cover 128 has been attached to the valve body 100, sandwiching the circuitry 120, 124 in between, and after the connector 123 has been connected to the flexible circuit 120 and then fixed to the cover 128. As shown in the Figure, the contact pads 122 remain exposed so that they can contact other components attached to the valve body 100, such as solenoids.

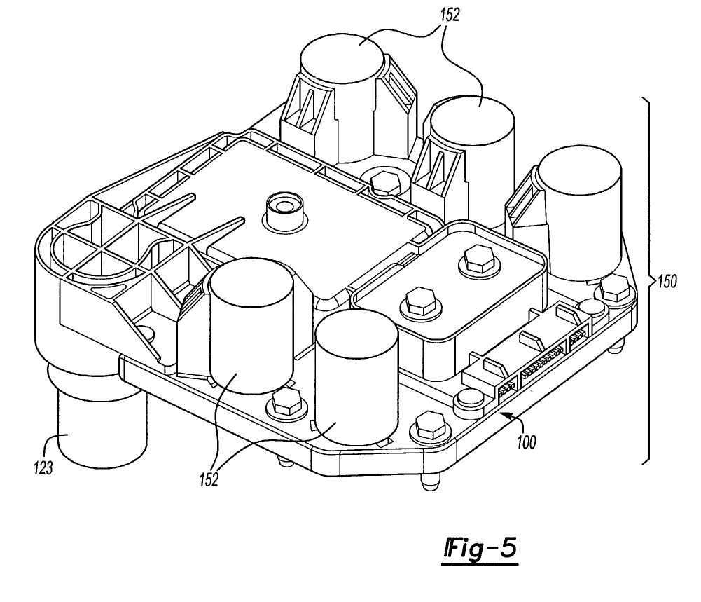

FIG. 5 illustrates a completed module 150 after solenoids 152 have been attached to the valve body 100. Because the module 150 eliminates the need for a separate circuit plate to support the electronic circuitry, the module 150 reduces the total number of transmission valve components that need to be connected to the transmission.

As a result, the inventive structure can integrate electronic control circuitry, a fluid routing structure, and solenoids for an electro-hydraulic transmission control into a single modular structure, reducing the overall number of parts needed to complete the transmission system, increasing reliability and reducing assembly costs. Further, by attaching the control circuitry directly to the valve body, the inventive structure does not require a separate circuit plate for electronic control and channel plate for fluid routing. This provides greater design flexibility because changes in the channel configuration do not require corresponding changes in the control circuit to maintain connections between the control circuitry and the transmission valve.

Although a preferred embodiment of this invention has been disclosed, a worker of ordinary skill in the art would recognize that certain modifications would come within the scope of this invention. For that reason, the following claims should be studied to determine the true scope and content of this invention. CLAIMS

What is claimed is:

1. A transmission valve module, comprising:
a valve body having a top surface and at least one channel that routes transmission fluid;
at least one circuit disposed on the top surface; and
a cover disposed over at least a portion of said at least one circuit and attached to the valve body.

2. The transmission valve module of claim 1, wherein said at least one circuit is selected from the group consisting of a flexible circuit and a low temperature co-fired ceramic (LTCC) circuit.

3. The transmission valve module of claim 1, wherein said at least one circuit comprises a flexible circuit and a low temperature co-fired ceramic (LTCC) circuit.

4. The transmission valve module of claim 3, wherein the flexible circuit and the LTCC circuit are coupled together.

5. The transmission valve module of claim 3, wherein the flexible circuit is laminated to the top surface of the valve body.

6. The transmission valve module of claim 3, wherein a portion of the flexible circuit is not attached to the top surface of the valve body.

7. The transmission valve module of claim 3, wherein the LTCC circuit is attached to the top surface with adhesive.

8. The transmission valve module of claim 1, further comprising at least one solenoid attached to the top surface and coupled to said at least one circuit.

9. A transmission valve module, comprising:
a valve body having a top surface and a plurality of channels that route transmission fluid;
a flexible circuit having a first portion attached to the top surface and a second portion that is not attached to the top surface;
a second circuit attached to the top surface and coupled to the flexible circuit;
a cover attached to the valve body, wherein the cover covers the second circuit and the first portion of the flexible circuit;
a connector attached to the second portion of the flexible circuit and the cover; and
a plurality of solenoids attached to the top surface and the flexible circuit.

10. The transmission valve module of claim 9, wherein the first portion of the flexible circuit includes a plurality of contact pads that are not covered by the cover, and wherein the plurality of solenoids contact the plurality of contact pads when the solenoids are attached to the top surface.

11. The transmission valve module of claim 9, wherein the first portion of the flexible circuit is attached to the top surface via lamination.

12. The transmission valve module of claim 9, wherein the second circuit is a low temperature co-fired ceramic (LTCC) circuit.

13. The transmission valve module of claim 9, further comprising at least one pressure switch disposed in the cover.

14. A method of manufacturing a transmission valve module, comprising:
attaching at least one circuit to a top surface of a valve body;
attaching a cover covering said at least one circuit to the valve body, leaving at least one portion of said at least one circuit exposed; and
attaching at least one solenoid to at least one exposed portion of said at least one circuit.

15. The method of claim 14, wherein the act of attaching at least one circuit comprises:
laminating a flexible circuit to the top surface;
attaching a second circuit to the top surface with adhesive; and
coupling the flexible circuit and the second circuit together.

16. The method of claim 14, further comprising:
attaching a connector to one of said at least one exposed portions of the flexible circuit; and
attaching the connector to the cover.

17. The method of claim 16, wherein the act of attaching the connector is conducted via laser welding.
